(19) United States
(12) Patent Application Publication
(10) Pub. No.: US 2025/0198881 A1
(43) Pub. Date: Jun. 19, 2025

(54) STEERABLE SYNCHRONIZED WHEELSPEED DYNOMOMETER SYSTEM

(71) Applicant: Shean Huff, Knoxville, TN (US)

(72) Inventor: Shean Huff, Knoxville, TN (US)

(21) Appl. No.: 18/985,333

(22) Filed: Dec. 18, 2024

Related U.S. Application Data
(60) Provisional application No. 63/611,472, filed on Dec. 18, 2023.

(51) Int. Cl. G01M 17/007

(52) U.S. Cl. CPC G01M 17/007

(57) ABSTRACT

A system and method for a steerable synchronized wheel speed dynamometer system that passes steerable vehicle transmission power through a non-driven vehicle wheel includes an outer wheel hub bearing assembly, a power transmission device and a continuously variable (CV) transmission variable length drive shaft. The outer wheel hub bearing assembly includes a central portion having a through-bore aligned with a central axis of rotation of the outer wheel hub bearing assembly and a first roller bearing assembly mounted circumferentially around a portion of the central portion to support a central aperture in a hub of a non-driven wheel of the vehicle. The power transmission device receives the powered steerable transmission output via a power transfer shaft when received in the through-bore. The CV transmission drive shaft includes a variable length drive shaft angularly and rotatably connected to the power transmission device.

### CROSS REFERENCE TO RELATED APPLICATIONS

This application claims the benefit of U.S. Provisional Patent Application Ser. No. 63/611,472 filed Dec. 18, 2023. The disclosure of the application listed above is incorporated herein by reference in its entirety.

A system and method for a steerable synchronized wheel speed dynamometer system that passes steerable vehicle transmission power from a driven vehicle wheel through a first non-driven vehicle wheel to a second non-driven vehicle wheel.

### BACKGROUND

Chassis dynamometers provide power measurement at the vehicle wheels, mileage accumulation, emissions and fuel economy measurements. Since the early 1970s, all US vehicle OEM manufacturers have been required to run emissions and fuel economy certification tests on chassis dynamometers. Chassis dynamometers are typically divided into two-wheel drive (2WD) and four-wheel drive (4WD) configurations where roller type dynamometers are configured to mount vehicle wheels directly on a rolling drum such that vehicle tires roll similarly to rolling on a road surface, and hub mounted dynamometers are configured to remove the vehicle wheels from the vehicle and mount dynamometers directly to the vehicle hubs.

With the advent of self-driving safety features in production vehicles, there is a growing need for better research environments, as well as verification and validation capabilities to ensure that automated driving features operate safely and as intended.

In the 2020 article, “Why testing infrastructure for AVs needs attention,” Automotive Testing Technology International, Danny Shapiro, Senior Director Automotive at NVIDIA, identifies “[a] critical area that requires more focus, however, will be in the infrastructure used to train, test and validate production-level autonomous vehicles.” Taylor Manahan, Director of Advanced Mobility at the Transportation Research Center Inc., stated at the SAE 2020 Government Industry Meeting, that “[t]he more complex scenarios (involving 5+ actors) are getting quite time consuming and expensive to set up. NHTSA is looking for a validation tool to bridge the gap between simulation and on track for proving AV decision-making capabilities.”

Many would argue that these proposed environments should come in the form of high fidelity physics models, along with increased access to High Performance Computers (HPC) for computational load and large data centers to process and store the excessive amount of generated data. Others insist that the only accurate way to validate the functionality of automated driving systems is to actually run the testing software in the production vehicle using production level Electronic Control Units (ECUs) on the road. Both solutions carry inherent risks and cannot adequately handle the necessary workload either accurately, in the case of HPC modeling, or in a safe efficient manner in the case of on-road testing.

Therefore, there is now the need to test these systems in a laboratory environment on chassis dynamometers to monitor, record and analyze self-driving or autonomous safety features include braking, acceleration, and steering control.

However, typical roller-type dynamometers, as those used by all major vehicle manufacturers for emissions and fuel economy certification, do not allow for the vehicle steering system to be actuated. There are currently steerable dynamometer systems on the market that will, in fact, allow the actuation of the steering system, but these systems are quite expensive in the two-to-four-million-dollar range. In addition to the system cost, there is also a significant cost for additional infrastructure, (e.g., additional power requirements, digging or expanding a pit, facility down time, etc.), as well as a significant amount of time to install the dynamometer.

Additionally, there are a large number of 2WD dynamometers in the field only capable of rotating the drive wheels of the vehicle. Many vehicle safety features, including traction control, ABS, and vehicle stability control, will be disabled if all the wheel speed sensors are not rotating at a synchronous speed. It is very costly, time consuming, and a disruption to the facilities to upgrade from a 2-wheel drive to a 4-wheel drive dynamometer.

Therefore, there is a strong need for an affordable steerable synchronized wheel speed dynamometer system that, when testing autonomous driving features of the vehicle, enable the ability to both steer the vehicle and spin all four wheels at a synchronous speed.

### BRIEF SUMMARY

It should be appreciated that this Summary is provided to introduce a selection of concepts in a simplified form that are further described below in the Detailed Description. This Summary is not intended to be used to limit the scope of the claimed subject matter.

In some aspects, the techniques described herein relate to a system including: an outer wheel hub bearing assembly including: a first connection member configured to connect to a powered steerable transmission output of a vehicle; a central portion connected to the first connection member, the central portion having a through-bore aligned with a central axis of rotation of the outer wheel hub bearing assembly; a first roller bearing assembly mounted circumferentially around a portion of the central portion and having a roller bearing configured to support a central aperture in a hub of a non-driven wheel of the vehicle, and a second connection member connected to the roller bearing and further configured to connect to a first side of the non-driven wheel; and a rotational and thrust force locking mechanism.

The system further includes a power transmission device configured to receive the powered steerable transmission output, the power transmission device including: a power transfer shaft configured to be received by the through-bore of the central portion of the outer wheel hub bearing assembly, the power transfer shaft further configured to be connected to the rotational and thrust force locking mechanism when received within the through-bore; and a distal end opposite the power transfer shaft having a third connection member.

The system further includes a continuously variable (CV) transmission drive shaft including: a first end configured to be connected to the third connection member of the power transmission device; a variable length drive shaft angularly and rotatably connected to the first end; and an opposite distal end connected to the first end via the variable length drive shaft.

In some aspects, the techniques described herein relate to a system including: an outer wheel hub bearing assembly configured to connect to a powered steerable transmission output of a vehicle, and further configured to connect to a first side of a first non-driven wheel of the vehicle; a power transmission device configured to receive rotational power from the powered steerable transmission output of the vehicle via the outer wheel hub bearing assembly through the first non-driven wheel of the vehicle, wherein the first non-driven wheel of the vehicle is configured to be isolated from receiving the rotational power from the powered steerable transmission output of the vehicle.

The system further includes: a continuously variable (CV) transmission drive shaft connected at a first end to the power transmission device and configured to receive the rotational power from the powered steerable transmission output of the vehicle; a first 90-degree differential having a rotational input connected to an opposite distal end of the CV transmission drive shaft configured to receive the rotational power from the powered steerable transmission output of the vehicle, and a rotational output; an adjustable length drive shaft having a first end connected to the rotational output of the first 90-degree differential configured to receive the rotational power from the powered steerable transmission output of the vehicle, and an opposite distal end configured to be connected to the first end via an adjustable length mechanism.

The system further includes: a second 90-degree differential having a rotational input configured to be connected to the opposite distal end of the adjustable length drive shaft, and further configured to receive the rotational power from the powered steerable transmission output of the vehicle, and a rotational output; and a drive shaft having a first end connected to the rotational output of the second 90-degree differential, and further configured to receive the rotational power from the powered steerable transmission output of the vehicle, and an opposite distal end configured to be connected to a second non-driven wheel of the vehicle such that the second non-driven wheel of the vehicle receives the rotational power from the powered steerable transmission output of the vehicle.

In some aspects, the techniques described herein relate to a method includes providing an outer wheel hub bearing assembly configured to connect to a powered steerable transmission output of a vehicle, and further configured to connect to a first side of a first non-driven wheel of the vehicle.

The method further includes providing a power transmission device configured to receive rotational power from the powered steerable transmission output of the vehicle via the outer wheel hub bearing assembly, wherein the first non-driven wheel of the vehicle is configured to be isolated from receiving the rotational power from the powered steerable transmission output of the vehicle;

The method further includes: providing a continuously variable (CV) transmission drive shaft connected at a first end to the outer wheel hub bearing assembly and configured to receive the rotational power from the powered steerable transmission output of the vehicle; and providing a first 90-degree differential configured to receive the rotational power from the powered steerable transmission output of the vehicle via the CV transmission drive shaft.

The method further including: providing an adjustable length drive shaft configured to receive the rotational power from the powered steerable transmission output of the vehicle via the first 90-degree differential; providing a second 90-degree differential configured to receive the rotational power from the powered steerable transmission output of the vehicle via the adjustable length drive shaft; and providing a drive shaft having configured to receive the rotational power from the powered steerable transmission output of the vehicle vie the second 90-degree differential, and further configured to be connected to a second non-driven wheel of the vehicle such that the second non-driven wheel of the vehicle receives the rotational power from the powered steerable transmission output of the vehicle.

### BRIEF DESCRIPTION OF THE SEVERAL VIEWS OF THE DRAWINGS

The embodiments will be better understood from the following detailed description with reference to the drawings, which are not necessarily drawing to scale and in which:

FIG. 1 illustrates a steerable synchronized wheel speed dynamometer system;

FIG. 2 illustrates another steerable synchronized wheel speed dynamometer system;

FIG. 3 illustrates another steerable synchronized wheel speed dynamometer system;

FIG. 4 illustrates another steerable synchronized wheel speed dynamometer system;

FIG. 5 illustrates a roller dolly assembly;

FIG. 6 illustrates a load simulation device for use with a steerable synchronized wheel speed dynamometer system;

FIG. 7 illustrates a partial cross-sectional view of a front steerable synchronized wheel speed assembly;

FIG. 8 illustrates a front wheel assembly of the illustration of FIG. 7;

FIGS. 9A and 9B illustrate a partial cross-section view of a sub-assembly of the illustration of FIG. 7;

FIGS. 10A, 10B and 10C illustrate a top view of a steering sequence of a sub-assembly of the illustration of FIG. 7; and

FIG. 11 illustrates series of illustrations demonstrating a method of assembly of the front steerable synchronized wheel speed assembly 700 of FIG. 7.

### DETAILED DESCRIPTION

The steerable synchronized wheel speed dynamometer system described herein mechanically couples the front and rear wheels together to synchronize their respective wheel speeds to the drive wheels.

Generally, the steerable synchronized wheel speed dynamometer system is assembled and attached to at least a single side of the vehicle's wheels at a drive wheel hub of one steering wheel connected to a first CV half shaft, connected to an input side of a first gearbox. The first gearbox may include a rear differential gearbox or any type of gearbox that transfers a rotating input in a first direction to a rotating output in a substantially orthogonal direction to the rotation input. The output side of the first rear differential gearbox is connected to a driveshaft connected to an input of a second gearbox. The output of the second gearbox is connected to a second CV half shaft that is connected to at least one rear wheel of the vehicle.

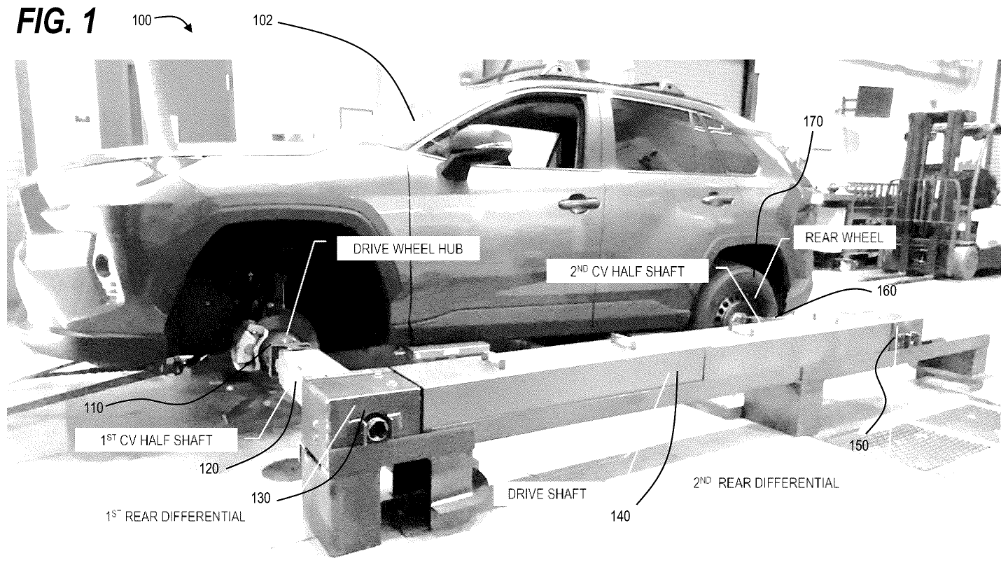

FIG. 1 illustrates a steerable synchronized wheel speed dynamometer system 100 configured to be connected to a vehicle 102 having front and rear wheels, (in this example, the front wheels are the wheels driven by a transmission of the vehicle 102). A drive wheel hub 110 of the vehicle 102 is configured to be connected to a first end of a first CV half shaft 120. A second end of the first CV half shaft 120 is further connected to an input of a first 90-degree differential 130. The output of the first 90-degree differential 130 is connected to a first end of a drive shaft 140, (enclosed in a safety shroud in FIG. 1). The second opposite end of the drive shaft 140 is connected to an input of a second 90-degree differential 150. An output of the second 90-degree differential 150 is connected to a first end of a second drive shaft 160. A second opposite end of the second drive shaft 160 is connected to a rear vehicle wheel 170 of the vehicle 102.

The steerable synchronized wheel speed dynamometer system initially is attached to one front drive wheel using a hub centric wheel spacer. Bolted directly to the wheel spacer is an opposing production wheel hub, with wheel spacer studs going through the hub's stud holes and with nuts applied.

Attached to the production wheel hub is a production constant-velocity (CV) half shaft, with a matching spline pattern. The CV half shaft is inserted into a left side of a rear differential. A spider gear, inside the differential, is welded solid such that both outputs are spinning at the same speed. Alternatively, any gear box may be used to transfer a rotational input from one direction to an orthogonal direction, for example, a right-angle bevel gearbox or T-type bevel gearbox. The right output of the rear differential is plugged with a stub spline that has been removed from a CV half shaft. The differential is equipped with a clutch pack that has been permanently locked, and the input of the differential is permanently coupled to the output of the differential. Alternatively, a gearbox may be used without any clutch pack where the input and output shafts are directly coupled to each other. The differential is positioned such that the input flange is facing the rear of the vehicle.

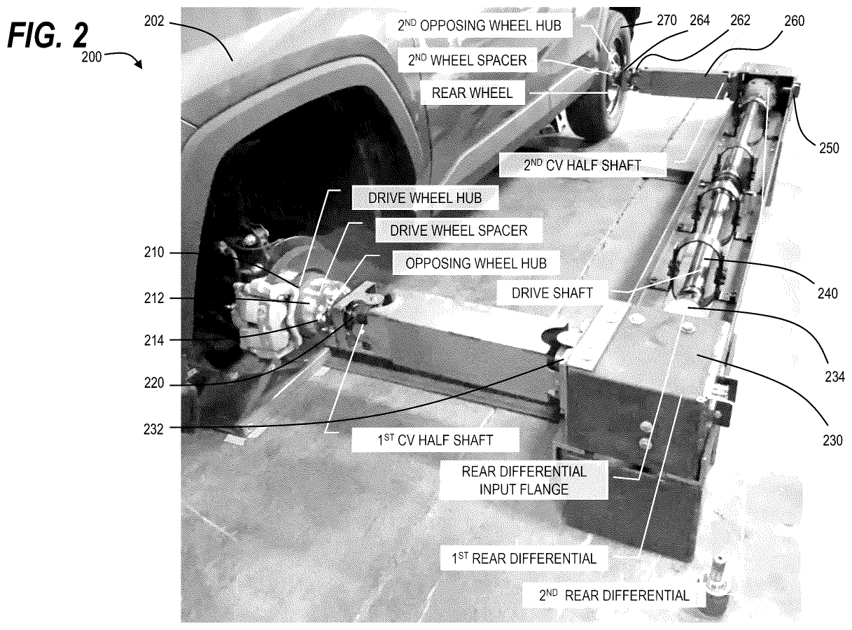

FIG. 2. illustrates another steerable synchronized wheel speed dynamometer system 200 configured to be connected to a vehicle 102 having front and rear wheels, (in this example, the front wheels are the wheels driven by the vehicle 202 transmission, similar to the illustration in FIG. 1). A drive wheel hub 210 of the vehicle 202 is configured to be connected to a first end of a drive wheel spacer 212. A second end of the drive wheel spacer 212 is connected to a first end of opposing drive wheel hub 214. An opposite end of the opposing drive wheel hub 214 is connected to a first end of the first CV half shaft 220, (enclosed in a safety shroud in FIG. 2). A second end of the first CV half shaft 220 is connected to a first differential input flange 232 of a first 90-degree differential 230. A first differential output flange 234 of the first 90-degree differential 230 is connected to a first end of a drive shaft 240. A second opposite end of the drive shaft 240 is connected to a second 90-degree differential 250. A first end of a second CV drive shaft 260, (enclosed in a safety shroud in FIG. 2), is connected to the second 90-degree differential 250. A second opposite end of the second CV drive shaft 260 is connected to a first side of a second wheel opposing wheel hub 262. A second side of the second wheel opposing wheel hub 262 is connected to a first side of a second wheel spacer 264. A second side of the second wheel spacer 264 is connected to a rear vehicle wheel 270 of the vehicle 202.

Connected to the input flange of the differential may be a drive shaft, with the other end of the drive shaft connected to the input flange of a second gearbox that may be facing forward. A second CV half shaft may be then connected to the right side of the second gearbox, which also has its spider gear welded and clutch pack locked. The CV half shaft may be then connected to a second production wheel hub, which may be in turn connected to a second hub centric wheel spacer. The second wheel spacer may be attached to the rear lug bolts of the vehicle rear wheel, with a steel wheel inserted in between. The rear wheel then rests on the rollers of a 2WD or 4WD roller type chassis dynamometer used to absorb road load. The system may be supported by a built frame and all of the rotating parts are protected by shaft guards.

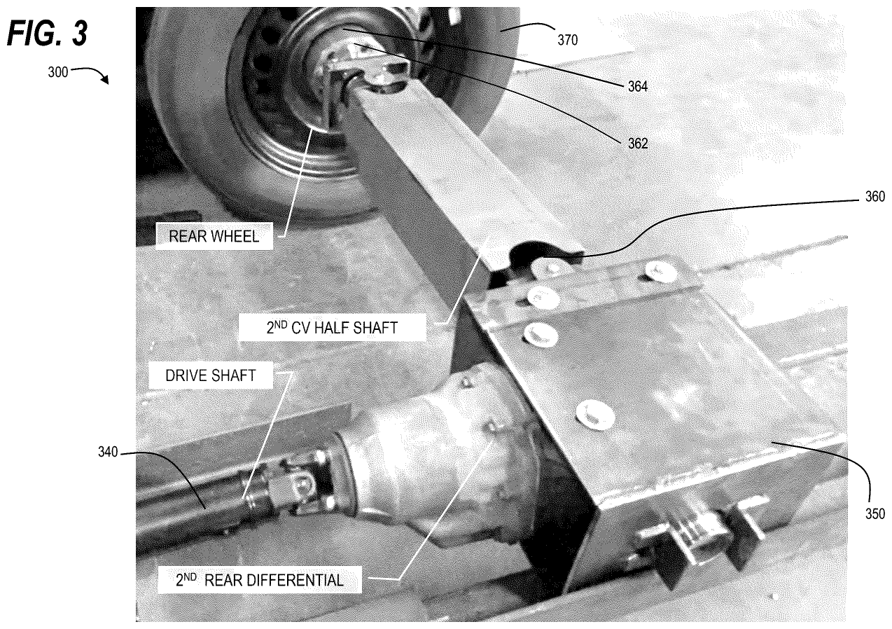

FIG. 3 illustrates another synchronized steerable wheel speed dynamometer system 300 for the rear non-driven vehicle wheel 370. A second input end of a drive shaft 340 is connected at an input of a second 90-degree differential 350. A first end of a second drive shaft 360, (enclosed in a safety shroud in FIG. 3), is connected to an output of the second 90-degree differential 350. A second end of the second CV drive shaft 360 is connected to a first side of a second wheel opposing wheel hub 362. An opposite side of the second wheel opposing wheel hub 362 is connected to a first side of a second wheel spacer 364. A second side of the second wheel spacer 364 is connected to the rear non-driven vehicle wheel 370 of the vehicle as illustrated in FIGS. 1 and 2.

The articulated front CV half shaft is configured to allow the front steering system to be actuated.

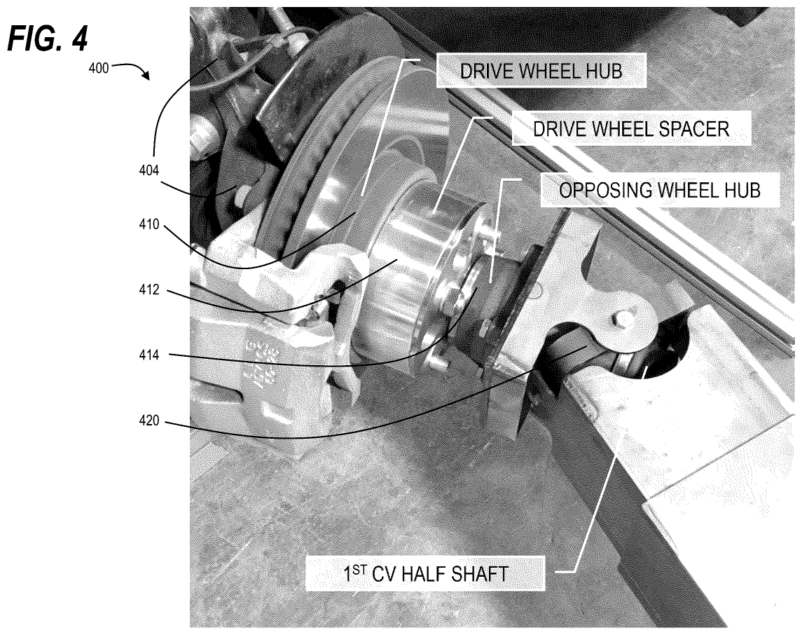

FIG. 4 illustrates another steerable synchronized wheel speed dynamometer system 400 including a first side of a vehicle steering linkage 404 connected to a drive wheel hub 410, (for example, an outwardly facing disc brake). The drive wheel hub 410 is connected to a first side of a drive wheel spacer 412. A second side of the drive wheel spacer 412 is connected to a first side of a opposing drive wheel hub 414. A second side of the opposing drive wheel hub 414 is connected to a first end of a first CV half shaft 420.

An alternative to the above-described system may be to have a belt driven system where the rear differential and the drive shaft is replaced with a system of belts and pulleys configured to transfer rotation between the front wheels and rear wheels.

A further alternative to the above-described system may provide rigidly mounted hub dynamometers connected to an articulating CV half shaft on a first end and the second end of the articulating CV half shaft connected to the vehicle wheel to allow the front steering system to be actuated.

### Technical Feature Specifications of the System

The steering capability of the dynamometer is achieved using an articulation joint, such as a universal/Cardan joint or multiple universal/Cardan joints, Constant Velocity (CV) joint(s), or any combination of any number of articulation joints.

Ability to adjust the length (e.g., telescoping shaft, slip yoke, etc.) of the CV half shaft.

A slip yoke may be used to provide the ability of either the half shaft or the drive shaft to telescope or change length to accommodate the geometry changes from steering actuation or to adjust the overall length of the machine for different wheelbase lengths.

Transfer rotation and power from the drive wheels to non-drive wheels using any mechanical means, including belt, timing belt, chain, timing chain, rotating shaft, or other mechanical link.

A belt or chain may be used to transfer power and rotation from the front to the rear using a pulley or sprocket.

A rotating shaft may be used to transfer power and rotation from longitudinal direction to lateral direction using gears or pulleys and belts.

Directional-change gears, (for example, right angle or “T”), may be specially built, or provided off the shelf, or repurposed from some other application, implement, machine, or vehicle.

Lateral speed and power may be transferred from the gearbox or pulley system to the vehicle axle using half shafts, prop shafts, driveshafts, power take-off (PTO) shafts, or specialty made torque transfer shafts.

Lateral speed and power may be transferred from the gearbox or pulley system by direct coupling to the vehicle wheel, hub, brake rotor, lug nuts or bolts, or axle.

Coupling to the vehicle may be done with either the wheel present or the wheel removed.

The lateral torque transfer may be done by connecting to any of the vehicle axle components directly or with a spacer or coupling in between.

Lug bolt extenders or hub centric wheel spacers may be configured to facilitate coupling of the torque transfer shaft to the vehicle axle.

Coupling from the lateral transfer shaft to the vehicle axle may be configured using off the shelf axle parts, aftermarket hub adapters, or custom-made couplings/adapters.

Rotating shaft guards or belt guards may be implemented from aftermarket parts or custom-made shielding/casings.

Shaft guards may include articulating members and pivot joints to match the articulation of the torque transfer connections to the steering axle to allow the actuation of the vehicle's steering mechanism and functionality.

Shaft guards may include articulating members and pivot joints to match the articulation of the torque transfer connections to the axles to account for misalignment of the machine to the centerline of the vehicle axle, (e.g., horizontal, vertical, etc.).

Shaft guards may include telescoping members to match the telescoping of the torque transfer shafts.

Modifications may be made to the longitudinal to lateral gearboxes, such as welding the differential spider gears to produce a solid axle torque transfer.

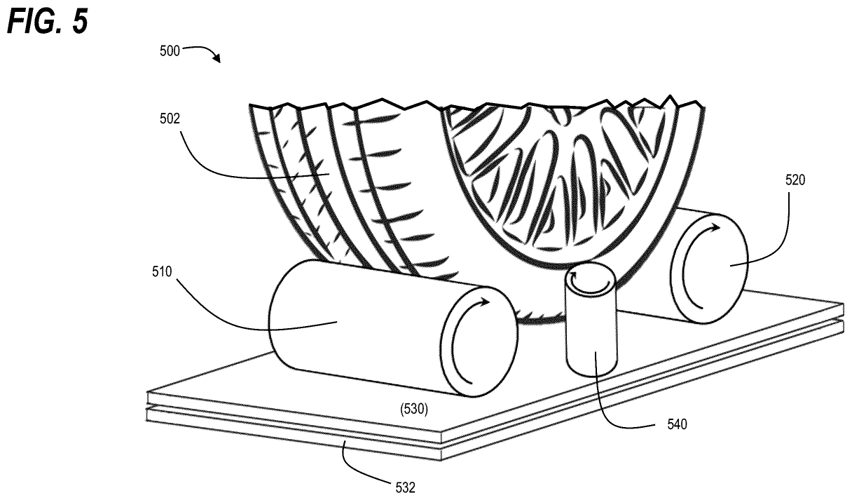

Roller dollies may be configured to allow the front drive wheels to contact the roller surface(s) and bear the vehicle weight, as illustrated in FIG. 5.

FIG. 5 illustrates a roller dolly assembly 500 including a forward retaining roller 510 and a rearward retaining roller 520 that may be mounted horizontally on an upper flat plate 530 with a pair of vertical rollers, for example, a vertical roller 540, (and an equivalent vertical roller on the opposite face of the vehicle wheel, not shown), such that they cradle a front steering wheel 502, with forward retaining roller 510 and rearward retaining roller 520 mounted vertically and able to adjust to the width of the tire. The upper flat plate 530 is then set on another lower flat bearing plate 532 with roller bearings between the plates, such that the upper flat plate 530 may rotate and translate on top of the lower flat bearing plate 532. This mechanism allows the front steering wheel 502 to spin on the rollers and rotate with the steering system actuation.

Steering force control may be added to the above-disclosed system by further attaching a member to the machine's hub, parallel to the vehicle's rotor, that swings with the steering action. Another member may be fixed by being placed under the scissor jack located under the vehicle's A-arm. The swinging member may be linked to the fixed member with an air actuated piston cylinder being pressurized by shop air, such that at a preset pressure, e.g., 50 psi, where a resistance force on the steering system may be approximated to the steering force generated at a standstill on dry pavement. Using a feedback-controlled solenoid valve, the piston pressure may be controlled directly to correspond to the wheel speed, such that the steering force required to compress the piston is approximately equal to the steering force that would be normally experienced at a given speed.

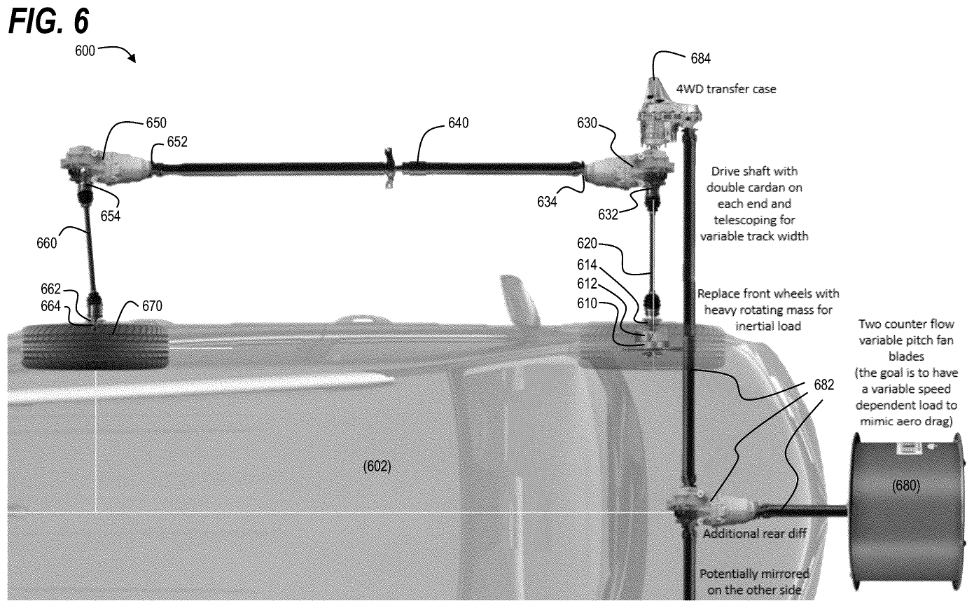

A power absorption accessory, or a load simulation device, may take power from any of the rotating members of the steerable synchronized wheel speed dynamometer system to drive a power transfer mechanism, for example, a fan, being configured to provide a resistive force that proportional to the vehicle wheel speed. Additionally, for example, a fan configured as a load simulation device may provide cooling to the vehicle powertrain and coolant system, as illustrated in FIG. 6.

FIG. 6 illustrates a load simulation device for use with a steerable synchronized wheel speed dynamometer system 600 for a vehicle 602 that includes a drive wheel hub 610 that receives driving power via the vehicle 602 transmission powerline. A first side of a drive wheel spacer 612 connects to the drive wheel hub 610 and an opposing side of drive wheel spacer 612 connects to a first side of an opposing drive wheel hub 614. A second side of the opposing drive wheel hub 614 is connected to a first end of a first CV half shaft 620, and a second opposite end of the first CV half shaft 620 is connected to a first differential input flange 632 of a first 90-degree differential 630. A first differential output flange 634 of the first 90-degree differential 630 is connected to a first end of a drive shaft 640. The drive shaft 640 may include a telescopic sliding section configured to allow the drive shaft 640 to change its length based on a wheelbase length of the vehicle 602.

A first differential input flange 652 of a second 90-degree differential 650 is connected to an opposite end of the drive shaft 640. A first differential output flange 654 of the second 90-degree differential 650 is connected to a first end of a second CV drive shaft 660. An opposite end of the second CV drive shaft 660 is connected to a first side of a second wheel opposing wheel hub 662. A second side of the second wheel opposing wheel hub 662 is connected to a first side of a second wheel spacer 664, and a second opposite side of the second wheel opposing wheel hub 662 is connected to a rear vehicle wheel 670.

A simulation device 680, for example, a fan that may include counter revolving variable pitch blades, may be connected via a load transfer path 682, (for example, a plurality of variable length telescoping drive shafts, and a differential), that may be connected to a load transfer case 684 connected to the first 90-degree differential 630. The simulation device may include a motor or any other device configured to add a load to the vehicle transmission power output corresponding to the vehicle wheel speed. The simulation device 680 may also be connected to the steerable synchronized wheel speed dynamometer system 600 via any other powered rotating mechanism, for example, the drive shaft 640, the second 90-degree differential 650, the first CV half shaft 620 or the second CV drive shaft 660.

Alternatively, a simplified may include a parallel torque transfer gearbox substituted for the load transfer case 684, a T-type torque transfer bevel gearbox may be substituted for the front differential gearbox, a right-angle torque transfer bevel gearbox may be substituted for the rear differential gearbox, and another T-type torque transfer bevel gearbox may be substituted for the forward differential gearbox.

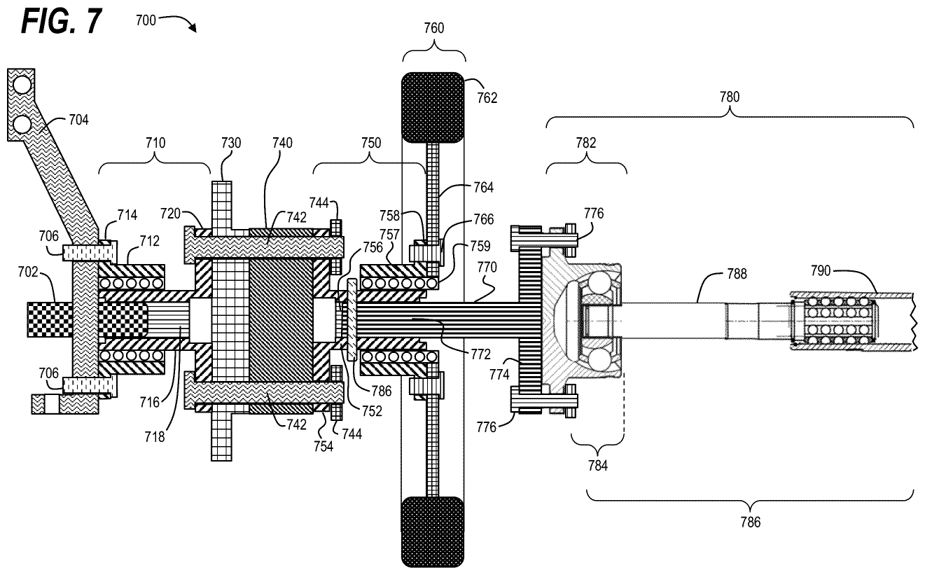

FIG. 7 illustrates a partial cross-sectional view of a front steerable synchronized wheel speed assembly 700 that includes a transmission power shaft 702 coming from a transmission of a driven vehicle, (not shown in FIG. 7). The distal end of the transmission power shaft 702 may pass around and/or through a steering knuckle 704 that controls the wheel steering angle of the front wheels.

A first end of a steering knuckle hub bearing assembly 710 may be connected to the steering knuckle 704 via rearward connection flange 714 and corresponding knuckle fasteners 706. The steering knuckle hub bearing assembly 710 further includes an axial roller bearing 712 that allows the power transmission of the transmission power shaft 702 to pass through the steering knuckle 704. The steering knuckle hub bearing assembly 710 further includes a central hub body 716 having an interior transmission power shaft receptacle 718 that receives the transmission power shaft 702. The steering knuckle hub bearing assembly 710 further includes a forward connection flange 720, opposite the rearward connection flange 714, for connecting to a first side of a vehicle disc brake 730.

A second opposite side of the vehicle disc brake 730 may be further connected to a first side of a cylindrical spacer 740 via spacer fasteners 742 and corresponding spacer fastener retention nuts 744.

A second side of the cylindrical spacer 740 may be further connected to a first side of an outward facing hub assembly 750 that includes a central hub body 752 at a rearward connection flange 754. The outward facing hub assembly 750 may further include, in the central hub body 752, an interior transmission power shaft receptacle 756 configured to receive a central splined shaft body portion 772, later described below. The outward facing hub assembly 750 may further include a circumferentially mounted bearing assembly 757 having a forward connection flange 758 for connecting to a non-powered wheel hub 764 of a non-powered wheel assembly 760. The outward facing hub assembly 750 may further include a assembly roller bearing 759 mounted around the central hub body 752 of the outward facing hub assembly 750 and supporting the non-powered wheel hub 764 at a central opening.

The non-powered wheel assembly 760 at the non-powered wheel hub 764 may be fastened via non-powered wheel connection fasteners 766 to the forward connection flange 758 of the circumferentially mounted bearing assembly 757 of the outward facing hub assembly 750. This configuration allows the non-powered wheel assembly 760 to rotate independently of the output connection of the transmission power shaft 702 being transmitted to the central hub body 752 of the outward facing hub assembly 750.

A power transmission shaft 770 includes a central splined shaft body portion 772 that may be received within the interior transmission power shaft receptacle 756 of the outward facing hub assembly 750 to receive powered rotational output connection of the transmission power shaft 702 being conveyed through the steering knuckle hub bearing assembly 710, the vehicle disc brake 730, the cylindrical spacer 740 and to the outward facing hub assembly 750.

The power transmission shaft 770 further includes a forward connection flange 774 opposite a distal end opposite of the central splined shaft body portion 772. An outward facing portion of the forward connection flange 774 may be configured to be connected to a CV shaft assembly 780 via shaft fasteners 776.

The CV shaft assembly 780 may further include a CV shaft connection assembly 782 that is connected via shaft fasteners 776 at a rearward face to the forward connection flange 774 of the power transmission shaft 770. The CV shaft connection assembly 782 may further include a CV shaft socket assembly 784 for retaining, with rotation motion, a first end of a CV shaft member assembly 786 having a CV shaft first telescopic member 788 in a sliding reciprocating relationship with a CV shaft second telescopic member 790.

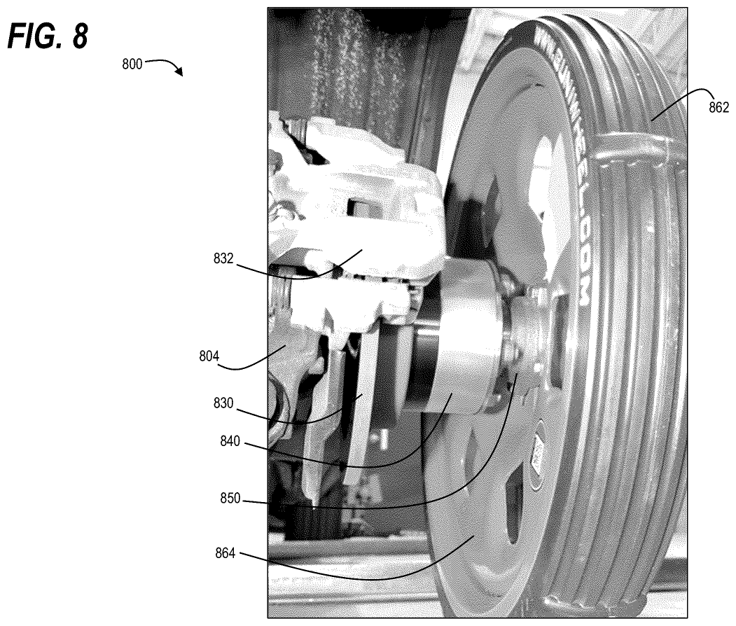

FIG. 8 illustrates a front wheel assembly 800 of the illustration of FIG. 7. In FIG. 8, a front wheel area of a vehicle includes a steering knuckle 804, connected to a steering knuckle hub bearing assembly, (not clearly illustrated in full, but similar to the steering knuckle hub bearing assembly 710), that is connected on an outward facing portion to a rearward facing portion of vehicle disc brake 830 actuated by a vehicle disc brake caliper 832.

An outward facing portion of the vehicle disc brake 830 may further connected to a rearward facing portion of cylindrical spacer 840. A forward facing portion of the cylindrical spacer 840 may further be connected to a rearward facing portion of an outward facing hub assembly 850, (similar to the outward facing hub assembly 750 of FIG. 7).

A forward facing portion of the outward facing hub assembly 850 may be connected to a rearward facing central portion of a non-powered wheel hub 864 of a non-powered wheel 862, (similar to the non-powered wheel assembly 760 of FIG. 7).

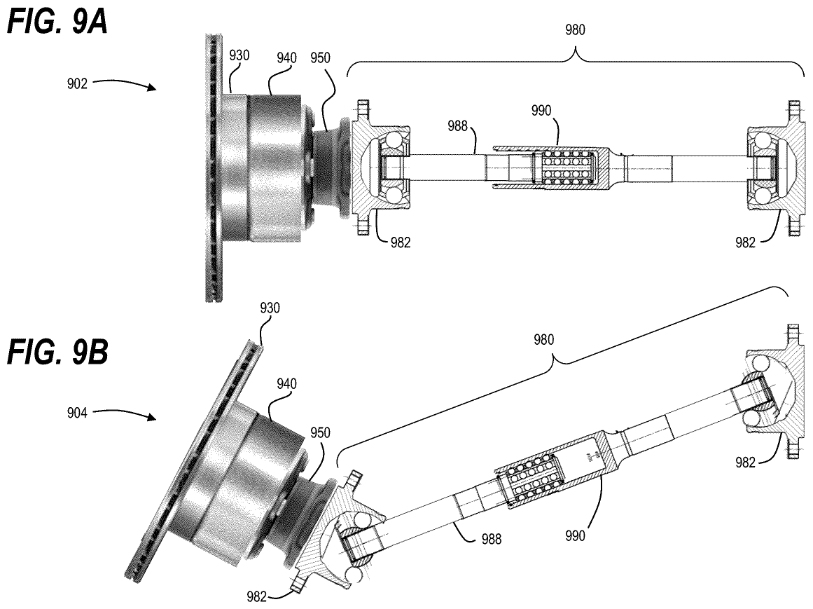

FIGS. 9A and 9B illustrate a partial cross-section view of a sub-assembly of the illustration of FIG. 7, without the non-powered wheel assembly 760, to demonstrate the operation of the CV shaft assembly 780 during a steering operation of the front wheel of a vehicle.

FIG. 9A illustrates a first view of the partial cross-section view of the sub-assembly 902 of the illustration of FIG. 7 in a non-extending neutral steering angle of a front wheel of a vehicle. Transmission power is communicated to a vehicle disc brake 930 connected to a cylindrical spacer 940 and further connected to an outward facing hub assembly 950, (similar to outward facing hub assembly 750 of FIG. 7). The outward portion of the outward facing hub assembly 950 is further connected to a CV shaft assembly 980 at a first member of opposing CV shaft connection assemblies 982. A first end of a CV shaft first telescopic member 988 is slidingly engaged within an interior portion of a corresponding end of a CV shaft second telescopic member 990.

In the configuration illustrated in FIG. 9A, at the neutral steering angle when no steering input is acting on the vehicle wheel, the first end of the CV shaft first telescopic member 988 is fully engaged within the corresponding end of the CV shaft second telescopic member 990.

FIG. 9B illustrates a second view of the partial cross-section view of the sub-assembly 904 of the illustration of FIG. 7 in an extending positive steering angle of the front wheel of the vehicle of FIG. 9A, In the configuration illustrated in FIG. 9B, at the positive steering angle when a steering input is acting on the vehicle wheel, the first end of the CV shaft first telescopic member 988 is extended away from the corresponding end of the CV shaft second telescopic member 990.

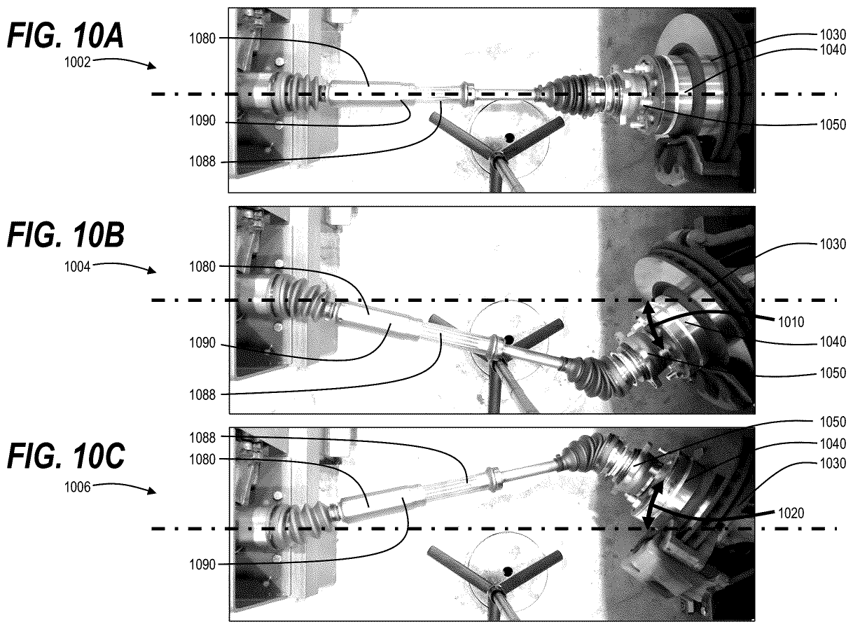

FIGS. 10A, 10B and 10C illustrate a top view of a steering sequence of a sub-assembly of the illustration of FIG. 7, without the non-powered wheel assembly 760, to demonstrate the operation of the CV shaft assembly 780 during a steering operation of the front wheel of a vehicle.

FIG. 10A illustrates non-extended neutral steering angle view 1002 of a front wheel of a vehicle where transmission power is communicated to a vehicle disc brake 1030 connected to a cylindrical spacer 1040 and further connected to an outward facing hub assembly 1050, (similar to outward facing hub assembly 750 of FIG. 7). The outward portion of the outward facing hub assembly 1050 is further connected to a CV shaft assembly 1080. A first end of a CV shaft first telescopic member 1088 is slidingly engaged within an interior portion of a corresponding end of a CV shaft second telescopic member 1090.

FIG. 10B illustrates an extending negative steering angle of the front wheel of the vehicle of FIG. 10A, In the configuration illustrated in FIG. 10B, at the negative steering angle when a steering input is acting on the vehicle wheel, the first end of the CV shaft first telescopic member 1088 is extended away at a first angle 1010 in a first direction from the corresponding end of the CV shaft second telescopic member 1090.

FIG. 10C illustrates an extending positive steering angle of the front wheel of the vehicle of FIG. 10A, In the configuration illustrated in FIG. 10B, at the positive steering angle when a steering input is acting on the vehicle wheel, the first end of the CV shaft first telescopic member 1088 is extended away at a second angle 1020 in a second direction, opposite the first direction of FIG. 10B, from the corresponding end of the CV shaft second telescopic member 1090.

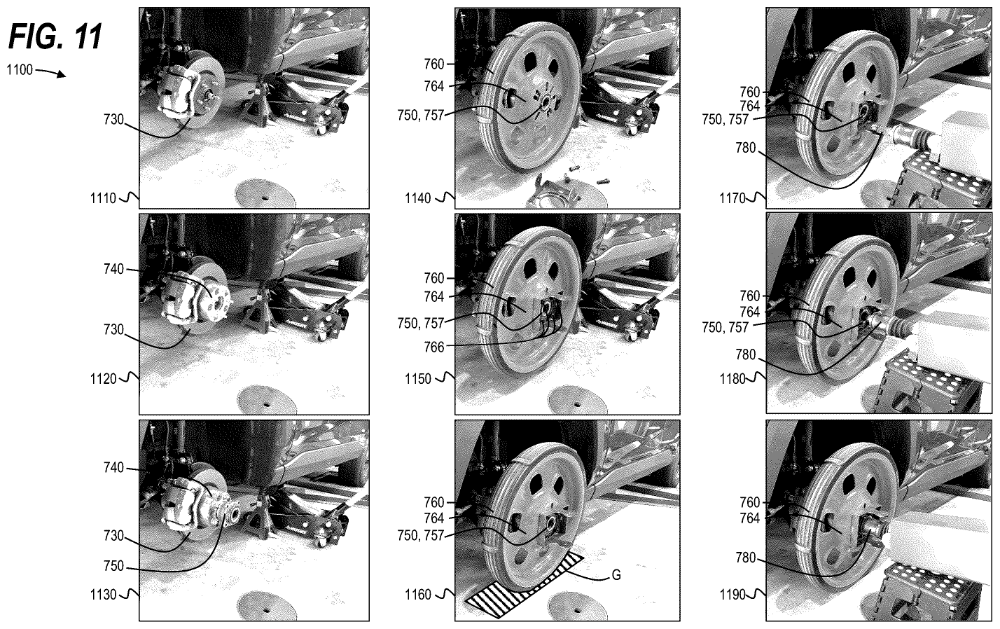

FIG. 11 illustrates series of illustrations, (reference numbers 1110 to 1190), demonstrating a method of assembly of the front steerable synchronized wheel speed assembly 700 of FIG. 7. (Reference numbers presented in FIG. 11 directed toward the front steerable synchronized wheel speed assembly 700 correspond to the reference numbers of FIG. 7 for consistency and ease of explanation.)

A first operation 1110 illustrates an operation of raising the vehicle via a jack to enable removal of a vehicle wheel from a front wheel area that exposes the vehicle disc brake 730 configured to receive transmission power from the vehicle engine.

A second operation 1120 illustrates an operation to connect the cylindrical spacer 740 to the outward facing portion of the vehicle disc brake 730.

A third operation 1130 illustrates an operation to connect the outward facing hub assembly 750 to the outward facing portion of the cylindrical spacer 740.

A fourth operation 1140 illustrates an operation to attach of the non-powered wheel assembly 760 on the outward facing circumferentially mounted bearing assembly 757 and forward connection flange 758 of the outward facing hub assembly 750. The circumferentially mounted bearing assembly 757 protrudes through and supports a central aperture in the non-powered wheel hub 764.

A fifth operation 1150 illustrates an operation to attach non-powered wheel connection fasteners 766 though fastener apertures in the non-powered wheel hub 764.

A sixth operation 1160 illustrates an operation to lower the vehicle such that the non-powered wheel assembly 760 supports a portion of the weight of the vehicle on the ground surface G.

A seventh operation 1170 illustrates an operation to align central splined shaft body portion 772 of a power transmission shaft 770 attached to a CV shaft assembly 780 with a corresponding interior transmission power shaft receptacle 718 of the steering knuckle hub bearing assembly 710.

An eighth operation 1180 illustrates an operation to insert the central splined shaft body portion 772 of a power transmission shaft 770 attached to the CV shaft assembly 780 into the corresponding interior transmission power shaft receptacle 718 of the steering knuckle hub bearing assembly 710.

A ninth operation 1190 illustrates an operation to connect and secure the central splined shaft body portion 772 of a power transmission shaft 770 to be rotationally attached to the CV shaft assembly 780 into the corresponding interior transmission power shaft receptacle 718 of the steering knuckle hub bearing assembly 710.

In some aspects, the techniques described herein relate to a system including: an outer wheel hub bearing assembly including: a first connection member configured to connect to a powered steerable transmission output of a vehicle; a central portion connected to the first connection member, the central portion having a through-bore aligned with a central axis of rotation of the outer wheel hub bearing assembly; a first roller bearing assembly mounted circumferentially around a portion of the central portion and having a roller bearing configured to support a central aperture in a hub of a non-driven wheel of the vehicle, and a second connection member connected to the roller bearing and further configured to connect to a first side of the non-driven wheel; and a rotational and thrust force locking mechanism; a power transmission device configured to receive the powered steerable transmission output, the power transmission device including: a power transfer shaft configured to be received by the through-bore of the central portion of the outer wheel hub bearing assembly, the power transfer shaft further configured to be connected to the rotational and thrust force locking mechanism when received within the through-bore; and a distal end opposite the power transfer shaft having a third connection member; and a continuously variable (CV) transmission drive shaft including: a first end configured to be connected to the third connection member of the power transmission device; a variable length drive shaft angularly and rotatably connected to the first end; and an opposite distal end connected to the first end via the variable length drive shaft.

In some aspects, the techniques described herein relate to a system, wherein the variable length drive shaft of the CV transmission drive shaft further includes an adjustable length splined connection between the first end and the opposite distal end.

In some aspects, the techniques described herein relate to a system, wherein the rotational and thrust force locking mechanism of the outer wheel hub bearing assembly includes a splined inner surface of the through-bore.

In some aspects, the techniques described herein relate to a system, wherein the rotational and thrust force locking mechanism of the outer wheel hub bearing assembly further includes a locking pin configured to pass through the central portion of the outer wheel hub bearing assembly and into the power transfer shaft of the power transmission device.

In some aspects, the techniques described herein relate to a system, wherein the powered steerable transmission output of the vehicle is configured to pass through the non-driven wheel of the vehicle without providing any rotation power to the non-driven wheel of the vehicle.

In some aspects, the techniques described herein relate to a system, wherein the outer wheel hub bearing assembly is configured to be connected to a brake rotor of the vehicle to receive the powered steerable transmission output of the vehicle.

In some aspects, the techniques described herein relate to a system, further includes a spacer connected at a first side to the first connection member of the outer wheel hub bearing assembly and at a second opposite side to the powered steerable transmission output of the vehicle.

In some aspects, the techniques described herein relate to a system including: an outer wheel hub bearing assembly configured to connect to a powered steerable transmission output of a vehicle, and further configured to connect to a first side of a first non-driven wheel of the vehicle; a power transmission device configured to receive rotational power from the powered steerable transmission output of the vehicle via the outer wheel hub bearing assembly through the first non-driven wheel of the vehicle, wherein the first non-driven wheel of the vehicle is configured to be isolated from receiving the rotational power from the powered steerable transmission output of the vehicle; a continuously variable (CV) transmission drive shaft connected at a first end to the power transmission device and configured to receive the rotational power from the powered steerable transmission output of the vehicle.

The system further including: a first 90-degree differential having a rotational input connected to an opposite distal end of the CV transmission drive shaft configured to receive the rotational power from the powered steerable transmission output of the vehicle, and a rotational output; an adjustable length drive shaft having a first end connected to the rotational output of the first 90-degree differential configured to receive the rotational power from the powered steerable transmission output of the vehicle, and an opposite distal end configured to be connected to the first end via an adjustable length mechanism.

The system further including: a second 90-degree differential having a rotational input configured to be connected to the opposite distal end of the adjustable length drive shaft, and further configured to receive the rotational power from the powered steerable transmission output of the vehicle, and a rotational output; and a drive shaft having a first end connected to the rotational output of the second 90-degree differential, and further configured to receive the rotational power from the powered steerable transmission output of the vehicle, and an opposite distal end configured to be connected to a second non-driven wheel of the vehicle such that the second non-driven wheel of the vehicle receives the rotational power from the powered steerable transmission output of the vehicle.

In some aspects, the techniques described herein relate to a system, wherein the CV transmission drive shaft further includes an adjustable length splined connection between the first end and the opposite distal end.

In some aspects, the techniques described herein relate to a system, wherein the powered steerable transmission output of the vehicle is configured to pass through the first non-driven wheel of the vehicle without providing any rotation power to the first non-driven wheel of the vehicle.

In some aspects, the techniques described herein relate to a system, wherein the outer wheel hub bearing assembly is configured to be connected to a brake rotor of the vehicle to receive the powered steerable transmission output of the vehicle.

In some aspects, the techniques described herein relate to a system, further includes a spacer connected at a first side to the outer wheel hub bearing assembly and at a second opposite side to the powered steerable transmission output of the vehicle.

In some aspects, the techniques described herein relate to a system, further includes an engine load simulation element configured to generate a vehicle wind resistance load corresponding to a simulated vehicle velocity corresponding to a vehicle wheel rotational speed, the engine load simulation element configured to connect to at least one of: the CV transmission drive shaft; the first 90-degree differential; the adjustable length drive shaft; the second 90-degree differential; and the drive shaft.

In some aspects, the techniques described herein relate to a method including: providing an outer wheel hub bearing assembly configured to connect to a powered steerable transmission output of a vehicle, and further configured to connect to a first side of a first non-driven wheel of the vehicle, providing a power transmission device configured to receive rotational power from the powered steerable transmission output of the vehicle via the outer wheel hub bearing assembly, wherein the first non-driven wheel of the vehicle is configured to be isolated from receiving the rotational power from the powered steerable transmission output of the vehicle; providing a continuously variable (CV) transmission drive shaft connected at a first end to the outer wheel hub bearing assembly and configured to receive the rotational power from the powered steerable transmission output of the vehicle.

The method further including: providing a first 90-degree differential configured to receive the rotational power from the powered steerable transmission output of the vehicle via the CV transmission drive shaft; providing an adjustable length drive shaft configured to receive the rotational power from the powered steerable transmission output of the vehicle via the first 90-degree differential.

The method further including: providing a second 90-degree differential configured to receive the rotational power from the powered steerable transmission output of the vehicle via the adjustable length drive shaft; and providing a drive shaft having configured to receive the rotational power from the powered steerable transmission output of the vehicle vie the second 90-degree differential, and further configured to be connected to a second non-driven wheel of the vehicle such that the second non-driven wheel of the vehicle receives the rotational power from the powered steerable transmission output of the vehicle.

In some aspects, the techniques described herein relate to a method, further includes providing an engine load simulation element configured to generate a vehicle wind resistance load corresponding to a simulated vehicle velocity corresponding to a vehicle wheel rotational speed, the engine load simulation element configured to connect to at least one of: the CV transmission drive shaft; the first 90-degree differential; the adjustable length drive shaft; the second 90-degree differential; and the drive shaft.

The foregoing description, for purpose of explanation, has been described with reference to specific arrangements and configurations. However, the illustrative examples provided herein are not intended to be exhaustive or to limit embodiments of the disclosed subject matter to the precise forms disclosed. Many modifications and variations are possible in view of the disclosure provided herein. The embodiments and arrangements were chosen and described in order to explain the principles of embodiments of the disclosed subject matter and their practical applications. Various modifications may be used without departing from the scope or content of the disclosure and claims presented herein.

What is claimed is:

1. A steerable synchronized wheel speed dynamometer system comprising:
an outer wheel hub bearing assembly including:
a first connection member configured to connect to a powered steerable transmission output of a vehicle;
a central portion connected to the first connection member, the central portion having a through-bore aligned with a central axis of rotation of the outer wheel hub bearing assembly;
a first roller bearing assembly mounted circumferentially around a portion of the central portion and having
a roller bearing configured to support a central aperture in a hub of a non-driven wheel of the vehicle, and
a second connection member connected to the roller bearing and further configured to connect to a first side of the non-driven wheel; and
a rotational and thrust force locking mechanism;
a power transmission device configured to receive the powered steerable transmission output, the power transmission device including:
a power transfer shaft configured to be received by the through-bore of the central portion of the outer wheel hub bearing assembly, the power transfer shaft further configured to be connected to the rotational and thrust force locking mechanism when received within the through-bore; and
a distal end opposite the power transfer shaft having a third connection member; and
a continuously variable (CV) transmission drive shaft including:
a first end configured to be connected to the third connection member of the power transmission device;
a variable length drive shaft angularly and rotatably connected to the first end; and
an opposite distal end connected to the first end via the variable length drive shaft.

2. The system of claim 1, wherein the variable length drive shaft of the CV transmission drive shaft further comprises an adjustable length splined connection between the first end and the opposite distal end.

3. The system of claim 1, wherein the rotational and thrust force locking mechanism of the outer wheel hub bearing assembly comprises a splined inner surface of the through-bore.

4. The system of claim 3, wherein the rotational and thrust force locking mechanism of the outer wheel hub bearing assembly further comprises a locking device configured to pass through the central portion of the outer wheel hub bearing assembly and into the power transfer shaft of the power transmission device.

5. The system of claim 1, wherein the powered steerable transmission output of the vehicle is configured to pass through the non-driven wheel of the vehicle without providing any rotation power to the non-driven wheel of the vehicle.

6. The system of claim 1, wherein the outer wheel hub bearing assembly is configured to be connected to a brake rotor of the vehicle to receive the powered steerable transmission output of the vehicle.

7. The system of claim 1, further comprises a spacer connected at a first side to the first connection member of the outer wheel hub bearing assembly and at a second opposite side to the powered steerable transmission output of the vehicle.

8. A steerable synchronized wheel speed dynamometer system comprising:
an outer wheel hub bearing assembly configured to connect to a powered steerable transmission output of a vehicle, and further configured to connect to a first side of a first non-driven wheel of the vehicle;
a power transmission device configured to receive rotational power from the powered steerable transmission output of the vehicle via the outer wheel hub bearing assembly through the first non-driven wheel of the vehicle, wherein the first non-driven wheel of the vehicle is configured to be isolated from receiving the rotational power from the powered steerable transmission output of the vehicle;
a continuously variable (CV) transmission drive shaft connected at a first end to the power transmission device and configured to receive the rotational power from the powered steerable transmission output of the vehicle;
a first 90-degree differential having a rotational input connected to an opposite distal end of the CV transmission drive shaft configured to receive the rotational power from the powered steerable transmission output of the vehicle, and a rotational output;
an adjustable length drive shaft having a first end connected to the rotational output of the first 90-degree differential configured to receive the rotational power from the powered steerable transmission output of the vehicle, and an opposite distal end configured to be connected to the first end via an adjustable length mechanism;
a second 90-degree differential having a rotational input configured to be connected to the opposite distal end of the adjustable length drive shaft, and further configured to receive the rotational power from the powered steerable transmission output of the vehicle, and a rotational output; and
a drive shaft having a first end connected to the rotational output of the second 90-degree differential, and further configured to receive the rotational power from the powered steerable transmission output of the vehicle, and an opposite distal end configured to be connected to a second non-driven wheel of the vehicle such that the second non-driven wheel of the vehicle receives the rotational power from the powered steerable transmission output of the vehicle.

9. The system of claim 8, wherein the CV transmission drive shaft further comprises an adjustable length splined connection between the first end and the opposite distal end.

10. The system of claim 8, wherein the powered steerable transmission output of the vehicle is configured to pass through the first non-driven wheel of the vehicle without providing any rotation power to the first non-driven wheel of the vehicle.

11. The system of claim 8, wherein the outer wheel hub bearing assembly is configured to be connected to a brake rotor of the vehicle to receive the powered steerable transmission output of the vehicle.

12. The system of claim 8, further comprises a spacer connected at a first side to the outer wheel hub bearing assembly and at a second opposite side to the powered steerable transmission output of the vehicle.

13. The system of claim 8, further comprises an engine load simulation element configured to generate a vehicle wind resistance load corresponding to a simulated vehicle velocity corresponding to a vehicle wheel rotational speed, the engine load simulation element configured to connect to at least one of:
the CV transmission drive shaft;
the first 90-degree differential;
the adjustable length drive shaft;
the second 90-degree differential; and
the drive shaft.

14. A method for a steerable synchronized wheel speed dynamometer system, the method comprising:
providing an outer wheel hub bearing assembly configured to connect to a powered steerable transmission output of a vehicle, and further configured to connect to a first side of a first non-driven wheel of the vehicle,
providing a power transmission device configured to receive rotational power from the powered steerable transmission output of the vehicle via the outer wheel hub bearing assembly, wherein the first non-driven wheel of the vehicle is configured to be isolated from receiving the rotational power from the powered steerable transmission output of the vehicle;
providing a continuously variable (CV) transmission drive shaft connected at a first end to the outer wheel hub bearing assembly and configured to receive the rotational power from the powered steerable transmission output of the vehicle,
providing a first 90-degree differential configured to receive the rotational power from the powered steerable transmission output of the vehicle via the CV transmission drive shaft;
providing an adjustable length drive shaft configured to receive the rotational power from the powered steerable transmission output of the vehicle via the first 90-degree differential;
providing a second 90-degree differential configured to receive the rotational power from the powered steerable transmission output of the vehicle via the adjustable length drive shaft; and
providing a drive shaft having configured to receive the rotational power from the powered steerable transmission output of the vehicle vie the second 90-degree differential, and further configured to be connected to a second non-driven wheel of the vehicle such that the second non-driven wheel of the vehicle receives the rotational power from the powered steerable transmission output of the vehicle.

15. The method of claim 14, further comprises providing an engine load simulation element configured to generate a vehicle wind resistance load corresponding to a simulated vehicle velocity corresponding to a vehicle wheel rotational speed, the engine load simulation element configured to connect to at least one of:
the CV transmission drive shaft;
the first 90-degree differential;
the adjustable length drive shaft;
the second 90-degree differential; and
the drive shaft.
